(19) United States
(12) Patent Application Publication
(10) Pub. No.: US 2024/0418922 A1
(43) Pub. Date: Dec. 19, 2024

(54) Optical Apparatus for Exciting a Sample, Analyzer and Method for Exciting a Sample

(71) Applicant: Robert Bosch GmbH, Stuttgart (DE)

(72) Inventors: Reinhold Fiess, Durbach (DE); Ingo Ramsteiner, Ettlingen (DE)

(21) Appl. No.: 18/707,592

(22) PCT Filed: Oct. 31, 2022
(86) PCT No.: PCT/EP2022/080324

§ 371 Date: May 5, 2024

(30) Foreign Application Priority Data
Nov. 8, 2021 (DE) 10 2021 212 505.0

(51) Int. Cl. G02B 5/32; B01L 3/00; G01N 21/63

(52) U.S. Cl. CPC G02B 5/32; B01L 3/502715; G01N 21/63; B01L 2300/0654; B01L 2300/168; G01N 2201/061

(57) ABSTRACT

An optical apparatus for exciting a sample in a microfluidic device disposed in a receiving region of an analyzer is disclosed. The apparatus has a light source for emitting a light beam and a holographic optical element for diverting at least a part of the light beam onto a projection surface of the microfluidic device in order to excite the sample disposed in the microfluidic device when the microfluidic device is disposed in the receiving region of the analyzer. The holographic optical element includes hologram regions which are designed to divert light of different wavelengths of the light beam in different beam directions onto a projection region of the projection surface.

### PRIOR ART

The invention is based on an optical apparatus for exciting a sample, an analyzer, and a method for exciting a sample according to one of the independent claims.

To analyze sample material, what are referred to as lab-on-chip cartridges comprising a sample can be inserted into analyzers and processed. For example, a molecular diagnostic assay can be disposed on a plastic cartridge comprising a microfluidic network. The analyzer can be designed to process such cartridges, i.e., it can control microfluidic processes on the cartridge and, e.g., heat or illuminate certain regions.

### Disclosure of the Invention

Against this background, the approach presented herein provides an improved optical apparatus for exciting a sample, an improved analyzer, and an improved method for exciting a sample according to the main claims presented. Advantageous embodiments of and improvements to the apparatus specified in the independent claim are made possible by the measures presented in the dependent claims.

The optical apparatus presented herein advantageously enables efficient projection of light onto a surface being illuminated by variable lighting options. In addition, the device has a compact design and can be implemented at low cost, particularly in view of its long service life.

Presented is an optical apparatus for exciting a sample in a microfluidic device disposed in a receiving region of an analyzer, the optical apparatus comprising a light source designed to emit a light beam. The optical apparatus further comprises a holographic optical element for diverting at least a part of the light beam onto a projection surface of the microfluidic device in order to excite the sample disposed in the microfluidic device when the microfluidic device is disposed in the receiving region of the analyzer. The holographic optical element comprises at least one first hologram region and a second hologram region, the first hologram region being designed to divert light of a first wavelength of the light beam in a first beam direction onto a first projection region of the projection surface, and the second hologram region being designed to divert light of a second wavelength of the light beam in a second beam direction onto the first projection region and, additionally or alternatively, a second projection region of the projection surface.

For example, the analyzer can be a device for performing diagnostic tests, such as rapid PCR tests. For example, a sample, which can be a liquid comprising sample material or a solid sample, can be introduced into a suitable microfluidic device, which can be a lab-on-chip cartridge comprising a microfluidic network for processing the sample. The microfluidic device with the sample can, e.g., be manually introduced into the analyzer's receiving region to be processed within the analyzer. The analyzer can in this case comprise the optical apparatus described herein, which can also be referred to as an optical unit, in order to excite the sample by means of illumination. For this purpose, the light source used in the device can, e.g., comprise one or multiple phosphor-converted laser diodes. The advantage of these is enabling the light to be optimally focused. Additionally or alternatively, the light source can comprise LEDs. Starting from the light source, the illumination distribution can be controlled using a light projector, such as a flying spot projector, for example, by directing the light beam using a micromechanical mirror. However, the light is not directed directly onto the surface being illuminated (the lab-on-chip cartridge), but indirectly via the holographic optical element (HOE), which performs a wavelength selection. The holographic optical element can comprise a surface consisting of multiple regions. Each of these hologram regions can comprise a hologram, preferably a volume hologram, which diverts a beam of light coming from the projector to a specific point on the projection surface. However, due to the intrinsic wavelength selectivity of the hologram, only light of a certain wavelength can be deflected accordingly. The first wavelength associated with the first hologram region can differ from the second wavelength. Accordingly, the first beam direction can differ from the second beam direction. The first wavelength can also stand for a first wavelength range, and the second wavelength correspondingly for a second wavelength range. Accordingly, one feature of the HOE is that the individual surfaces can be effective for different wavelengths. The optical apparatus is therefore advantageously designed to illuminate certain regions of the cartridge with light of a defined wavelength range in order to, e.g., excite fluorescence in that region. According to various embodiments, the holographic optical element can comprise any suitable number of hologram regions to divert light of any suitable number of different wavelengths to any suitable number of different projection regions. For example, the holographic optical element can comprise at least one group having any suitable number of hologram regions in order to divert light of different wavelengths to the same projection region associated with the group. Each hologram region of the group can be associated with a wavelength that differs from the wavelengths of the other hologram regions of the group. If the holographic optical element comprises a plurality of such corresponding groups, then each of the groups can be designed to divert light to a different projection region associated with the corresponding group. As a result, each group can be associated with its own projection region, which can differ from the projection regions of the other groups.

According to one embodiment, the optical apparatus can comprise a directing means, which can be designed to direct the light beam to one of the hologram regions in response to a directing signal. The directing means can, e.g., comprise a micromechanical mirror that can be set at certain angles using the directing signal in order to direct the light beam to a desired hologram region. For example, the hologram regions can be activated in a chronologically sequential manner (e.g., first the first hologram region and then the second hologram region), whereby the light beam deflected by the hologram regions can, e.g., be used to excite the same sample or to excite two different samples. Advantageously, the analysis process can be optimized and energy saved at the same time by precisely directing the light beam.

According to a further embodiment, the optical apparatus can comprise a control means, which can be designed to provide the directing signal and, additionally or alternatively, to provide an action signal for switching the light source on and off. For example, the control means can be designed to control a large number of analysis processes and thus advantageously optimize the execution of an analysis process. The control device can, e.g., be designed to use an identification signal to identify the insertion of the microfluidic device and additionally or alternatively the type of microfluidic device used and to provide the action signal and, e.g., the directing signal accordingly.

For this purpose, the control device can comprise at least one computing unit for processing signals or data, at least one memory unit for storing signals or data, at least one interface to a sensor or an actuator for reading in sensor signals from the sensor or for emitting data or control signals to the actuator, and/or at least one communication interface for reading in or emitting data embedded in a communication protocol. The computing unit may, for example, be a signal processor, a microcontroller or the like, wherein the memory unit may be a flash memory, an EEPROM, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “control device” can be understood to mean an electrical device that processes sensor signals and emits control signals and/or data signals as a function thereof. The control device can comprise an interface, which can be designed as hardware and/or software. For example, given a hardware design, the interfaces can be part of what is referred to as an ASIC system, which contains a wide variety of functions for the apparatus. However, it is also possible that the interfaces are separate integrated circuits or consist at least in part of discrete components. In a software design, for example, the interfaces can be software modules provided on a microcontroller in addition to other software modules.

According to a further embodiment, the light source can be designed to emit the light beam with at least one broad wavelength band and, additionally or alternatively, with a plurality of spaced-apart wavelength lines or wavelength bands. For example, the optical apparatus, or a projector used in the optical apparatus, can be based on a white light source, such as a phosphor-converted laser or a phosphor mix with multiple narrow emission bands, which can also be referred to as sharp wavelength lines. In this context, the term “white” is not necessarily understood to mean a color impression, but such that the spectrum cannot consist of a single, narrow wavelength band, but, e.g., of one or multiple broad bands, or at least multiple sharp lines. Advantageously, the light beam emitted by the light source can therefore contain all the wavelengths that are to be used to illuminate the projection surface.

According to a further embodiment, the holographic optical element can comprise at least one further hologram region, which can be designed to divert light of a further wavelength of the light beam in a further beam direction onto the first projection region and, additionally or alternatively, the second projection region and, additionally or alternatively, a further projection region of the projection surface. For example, the holographic optical element can be formed with any number of hologram regions that can divert light of a corresponding number of different wavelength ranges. Thus, each hologram region can be used to deflect light that differs in wavelength from the light that irradiates the other hologram regions. For example, between 4 and 6 corresponding hologram regions can be provided. As a result, the light beam is, on the one hand, able to be advantageously reduced to an optimum wavelength in order to analyze the sample and, on the other hand, the beam direction is also able to be directed as precisely as possible to the projection region where the sample is disposed.

According to a further embodiment, the holographic optical element can be designed to transmit at least a further part of the light beam. For example, each hologram region can be designed at a specific intrinsic wavelength selectivity, whereby only light of a certain wavelength can be deflected. The remaining parts of light, which may be irrelevant for the analysis process being performed can, e.g., pass through the holographic optical element and be absorbed behind it in a beam trap or a suitable surface. In this way, each sample can advantageously be illuminated using only one predetermined wavelength.

According to a further embodiment, the device can be designed to be able to illuminate the projection surface without gaps. For example, the holographic optical element can be designed with a plurality of hologram regions, whereby each hologram region can deflect a specific part of the light beam to a projection region disposed differently from one another. The individual projection regions can in this case directly border each other. The advantage of this is that a sample can be optimally illuminated, regardless of its position on the projection surface.

According to a further embodiment, the device can be designed to illuminate the first projection region and the second projection region at the same intensity. For example, a projection grid can be matched to the intrinsic beam divergence or the individual holograms can be designed so that they not only deflect the light beam, but can also shape the wavefront of the deflected light beam. This has the advantage that each sample can be optimally excited.

According to a further embodiment, the holographic optical element can comprise at least one additional first hologram region, whereby the additional first hologram region can be designed to divert light of the first wavelength of the light beam in an additional beam direction onto the first projection region and, additionally or alternatively, onto the second projection region of the projection surface. For example, the holographic optical element can comprise multiple hologram regions able to, e.g., illuminate identical points on the projection region with the same wavelength type. Advantageously, this makes it possible to vary the direction of illumination. This can be utilized in connection with inhomogeneous samples, for example, where the fluorescence may depend not only on the intensity but also on the direction of incidence of the excitation light. Additionally or alternatively, for example, the first and second projection regions can be exposed to the same wavelength, for example to excite two identical samples simultaneously.

According to a further embodiment, the holographic optical element can be formed in a flat shape and, additionally or alternatively, the hologram regions of the holographic optical element can be disposed in a matrix-like manner. Advantageously, the holographic optical element can be optimized to the requirements of the analysis process both in terms of its shape and the number and arrangement of the hologram regions. This means that the number of hologram regions that differ in relation to the respective wavelengths to be diverted and the total number of hologram regions and their arrangement can be selected appropriately.

Also presented is an analyzer for analyzing a sample in a microfluidic device, the analyzer comprising a receiving region for receiving the microfluidic device and a variant of the optical apparatus presented hereinabove.

Also presented is method for exciting a sample in a microfluidic device disposed in a receiving region of an analyzer, the method comprising a step of emitting a light beam. The method further comprises a step of diverting light of at least a first wavelength of the light beam in a first beam direction onto a first projection region of a projection surface of the microfluidic device in order to excite the sample disposed in the first projection region when the microfluidic device is disposed in the receiving region. Additionally or alternatively, the method comprises a step of diverting light of at least a second wavelength of the light beam in a second beam direction to the first projection region and, additionally or alternatively, a second projection region of the projection surface of the microfluidic device to excite the sample disposed in the first projection region when the microfluidic device is disposed in the receiving region.

Exemplary embodiments of the approach presented herein are shown in the drawings and explained in greater detail in the following description. Shown are:

FIG. 1 a schematic representation of an exemplary embodiment of an analyzer;

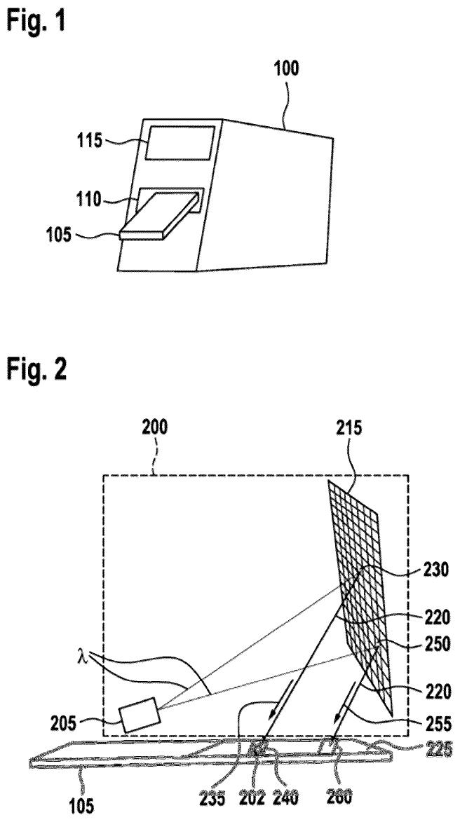

FIG. 2 a schematic representation of an optical apparatus according to an exemplary embodiment;

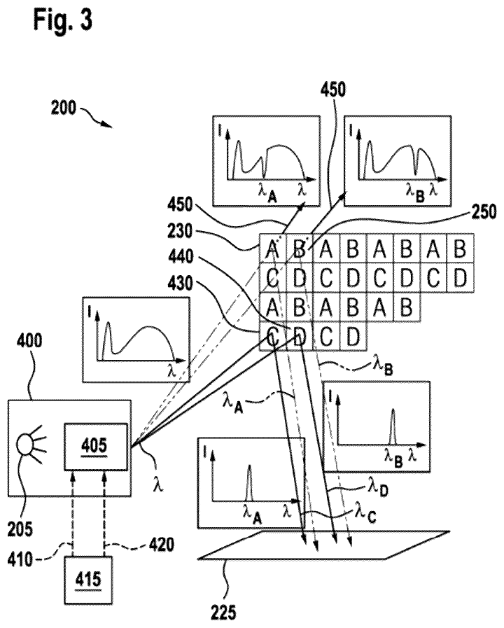

FIG. 3 a schematic representation of an exemplary embodiment of an optical apparatus;

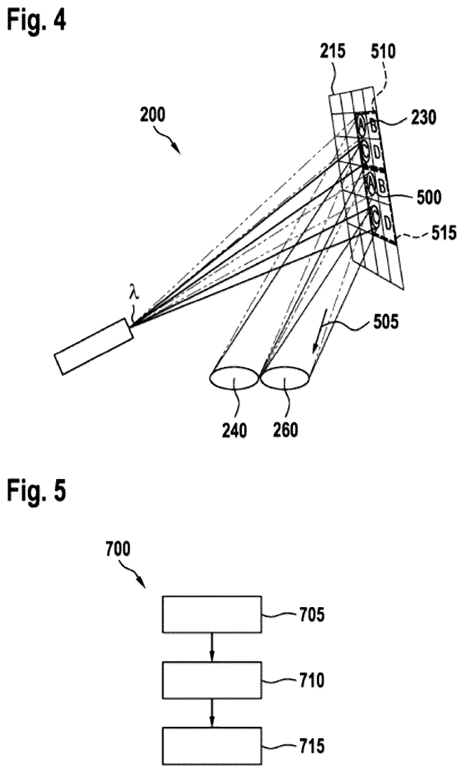

FIG. 4 a schematic representation of an exemplary embodiment of an optical apparatus; and

FIG. 5 a flow chart of a method for exciting a sample according to an exemplary embodiment.

In the following description of advantageous exemplary embodiments of the present invention, identical or similar reference signs are used for elements shown in the various drawings which having a similar function, so a repeated description of these elements has been omitted.

FIG. 1 shows a schematic representation of an exemplary embodiment of an analyzer 100. In this exemplary embodiment, the analyzer 100 is designed to analyze samples that have been introduced, as a result of which it is, e.g., possible perform PCR tests. For this purpose, a microfluidic device 105, which is merely an example of a cartridge with a plastic housing and a microfluidic network for processing the sample, can be inserted into a receiving region 110. In this exemplary embodiment, the analyzer further comprises a display 115 with a touch function, by means of which settings for the desired analysis process can be entered manually (by way of example only). The display 115 is, by way of example only, also designed to display analysis results.

In other words, the concept of the analyzer provides for the integration of a molecular diagnostic assay on a plastic cartridge with a microfluidic network. The actual device is designed to process such cartridges, i.e. it can control microfluidic processes on the cartridge and heat and additionally or alternatively illuminate certain regions. In particular, in this exemplary embodiment it comprises an optical apparatus, as described in more detail in FIGS. 2, 4 and 5 below, which can excite and evaluate fluorescence signals. By way of example, this unit consists of two parts: Firstly, a camera with interchangeable bandpass filters that views a specific region of the cartridge. Secondly, a device that can illuminate certain regions of the cartridge with light of a defined wavelength range in order to excite fluorescence there. These regions are disposed in the camera's field of view.

FIG. 2 shows a schematic representation of an optical apparatus 200 according to an exemplary embodiment. The optical apparatus 200 is usable in an analyzer, as described in the preceding figure, to excite a sample 202 disposed in a microfluidic device 105 by means of illumination. For this purpose, the optical apparatus 200 comprises a light source 205, which is designed to emit a light beam λ. In this exemplary embodiment, the light source 205 is designed as a projector (by way of example only), whereby the light beam λ can be emitted at a variable angle. By way of example, FIG. 2 shows two different emitting directions of the light beam 2, which can be assumed simultaneously or in succession according to different exemplary embodiments. In this exemplary embodiment, the light source 205 is further designed to emit the light beam λ at a plurality of broad wavelength bands. In another exemplary embodiment, the light beam can also be emitted with only one broad wavelength band or with a plurality of sharp wavelength lines.

Within the optical apparatus 200, the light beam λ can be directed onto a holographic optical element 215. The holographic optical element 215 (abbreviated as HOE for short) is designed to divert a part 220 of the light beam λ onto a projection surface 225 of the microfluidic device 105 in order to excite the sample 202 disposed in the microfluidic device 105. The holographic optical element 215 in this case comprises a first hologram region 230 designed to divert light of a first wavelength or a first wavelength range of the light beam λ in a first beam direction 235 to a first projection region 240 of the projection surface 225 at which the sample 202 to be excited is disposed in this exemplary embodiment.

The holographic optical element 215 also comprises a second hologram region 250 designed to divert light of a second wavelength or a second wavelength range of the light beam 2 in a second beam direction 255 to a second projection region 260 of the projection surface 225. By way of example only, the second projection region 260 in this exemplary embodiment can be illuminated at the same intensity as the first projection region 240. Moreover, in this exemplary embodiment, the holographic optical element 215 is designed with a plurality of further hologram regions in a planar shape, whereby the hologram regions are disposed in a matrix-like manner (by way of example only). By means of the light beam λ that can be directed and the large number of hologram regions, the projection surface 225 can be illuminated without gaps in this exemplary embodiment

In other words, the optical apparatus 200 is designed to control an illumination distribution by means of a light projector. In this exemplary embodiment, the light beam λ can only be directed by means of a flying spot projector using a micromechanical mirror (by way of example only). In this exemplary embodiment, the projector is based on a white light source 205, which is based on a phosphor-converted laser (by way of example only). In this context, the term “white” is not necessarily understood to mean a color impression, but rather that the spectrum does not consist of a single, narrow wavelength band, but rather one or multiple broad bands, or at least multiple sharp lines. It is important that it contains all the wavelengths that are to be used to illuminate the projection surface 225. However, the light cannot be directed directly onto the surface to be illuminated (the lab-on-chip cartridge), but indirectly via a holographic optical element 215, which performs a wavelength selection. For this purpose, the holographic optical element 215 has a surface comprising multiple regions (by way of example only). Each region comprises a hologram, which in this exemplary embodiment is a volume hologram that directs the light beam λ to a specific point on the projection surface 225. However, due to the intrinsic wavelength selectivity of the hologram, light is only deflected by a certain wavelength in order to excite the sample 202.

FIG. 3 shows a schematic representation of an exemplary embodiment of an optical apparatus 200. The optical apparatus 200 shown in this case corresponds to or is similar to the device described in the preceding FIG. 2. In this exemplary embodiment, the light beam λ can be provided by what is referred to as a flying spot projector 400, which is designed to direct a white beam over a certain angular range and also to switch it on and off during the scanning process in order to illuminate only selected positions in its projection range. For this purpose, the flying spot projector 400 comprises, by way of example only, the light source 205 and a directing device 405, which in this exemplary embodiment comprises a micromechanically movable mirror and is designed to direct the light beam λ onto one of the hologram regions of the holographic optical element 215 in response to a directing signal 410. In this exemplary embodiment, the directing signal 410 can, by way of example only, be provided by a control device 415. In this exemplary embodiment, the control device 415 is also designed to provide an action signal 420 for switching the light source 205 on and off, in addition to the directing signal 410.

By means of the directing device 405, the light beam λ in this exemplary embodiment can be directed onto a first hologram region 230, a second hologram region 250 of the holographic optical element 215. In this exemplary embodiment, the holographic optical element 215 additionally comprises a further hologram region 430 and, by way of example only, an additional hologram region 440, wherein the hologram regions 230, 250, 430, 440 are disposed in a matrix-like manner (by way of example only). The first hologram region 230 is designed to divert light of a first wavelength λ_{A} of the light beam λ in a first beam direction onto a first projection region of the projection surface 225, and the second hologram region 250 is designed to divert light of a second wavelength λ_{B} of the light beam λ in a second beam direction onto a second projection region of the projection surface 225. Similarly, in this exemplary embodiment, the additional hologram region 430 is designed to divert light of an additional wavelength λ_{C} of the light beam λ in an additional beam direction to an additional projection region of the projection surface 225, and the additional hologram region 440 is designed to divert light of an additional wavelength λ_{D} of the light beam λ in an additional beam direction to an additional projection region of the projection surface 225. In this exemplary embodiment, each individual hologram of the HOE therefore directs a wavelength-specific part of the light beam λ to a specific point on the projection surface 225, whereby the regions of the HOE shown labeled A, B, C and D each only process light with the wavelength λ_{A}, λ_{B}, λ_{C}, λ_{D}. Therefore, the light of the wavelengths λ_{A}, λ_{B}, λ_{C}, λ_{D} represents different parts of the light beam λ, which are selected and deflected by the hologram regions 230, 250, 430, 440. The spectra shown represent examples of the respective beams. In this exemplary embodiment, the beams traveling from the projector to the HOE thus comprise a broad spectrum, from which the A range deflects (by way of example) a narrow wavelength band with the central wavelength λ_{A} and the B range a narrow wavelength band with λ_{B}.

In other words, due to the intrinsic wavelength selectivity of the corresponding hologram, only light of a certain wavelength λ_{A}, λ_{B}, λ_{C} or λ_{D} can be deflected. A further part 450 of the light beam λ, i.e. the remaining parts of light, is transmitted in this exemplary embodiment and is absorbed by a blackened surface of the holographic optical element 215 (by way of example only). The relevant spectral bands of the wavelengths λ_{A}, λ_{B}, λ_{C}, λ_{D} are missing in the transmitted spectra. The individual surfaces of the HOE are effective for different wavelengths λ_{A}, λ_{B}, λ_{C}, λ_{D}. In this exemplary embodiment, the holographic optical element 215 is designed to divert four wavelengths λ_{A}, λ_{B}, λ_{C}, λ_{D} with a plurality of hologram regions. In another exemplary embodiment, however, the concept is not limited to four wavelengths, and the regions of the HOE can have a different shape than the square shape shown here, or different sizes, or follow a different symmetry in their arrangement.

Overall, the optical apparatus 200 shown in this case enables the illumination by light of one or multiple contiguous surfaces, e.g. on a lab-on-chip cartridge. The number, shape, and size of the surfaces can be freely selected within a certain range and can be flexibly controlled electronically. In this exemplary embodiment, the light itself meets the requirements for the fluorescence excitation of molecular diagnostic assays and also comprises multiple color channels for this purpose. This means a spectrum that is precisely defined in terms of center wavelength and width, or a plurality of such spectra, between which switching is possible.

The design with a white light flying spot projector described in this exemplary embodiment offers the advantage of particular light efficiency. Depending on the requirements profile of the specific application, other projector types (DLP, LCOS) can also be used in other exemplary embodiments. The image plane of the projector should be in the region of the HOE, in other words, the image of the projector should be focused on the HOE.

FIG. 4 shows a schematic representation of an exemplary embodiment of an optical apparatus 200. The optical apparatus 200 shown in this case corresponds to or is similar to the device described in the preceding FIGS. 2 and 3. In this exemplary embodiment, the holographic optical element 215 comprises, in addition to the first hologram region 230, an additional first hologram region 500 (by way of example only). In this exemplary embodiment, the additional first hologram region 500 is designed to divert light of the first wavelength of the light beam λ in an additional beam direction 505 to the second projection region 260 of the projection surface, while the first hologram region 230 is designed to divert light to the first projection region 240. By way of example only, the first hologram region 230 in this exemplary embodiment is designed as part of a first group 510 which comprises, by way of example, four HOE regions with different wavelengths that overlap in a common projection region, which in this exemplary embodiment corresponds to the first projection region 240. Similarly, in this exemplary embodiment, the additional first hologram region 500 is designed, by way of example only, as part of a second group 515, which also comprises, by way of example, four HOE regions with different wavelengths that overlap in a common projection region, which in this exemplary embodiment corresponds to the second projection region 260. As a result, the projection surface can be covered without gaps with each wavelength channel in this exemplary embodiment. In addition, it is possible to achieve the same intensity distribution with each channel (by way of example only). This can be achieved, by way of example only, by overlapping the individual HOE regions and requires precise coordination of the projection grid with the beam divergence, which is achieved in this exemplary embodiment by designing the individual holograms accordingly, so that they not only deflect the beam, by way of example, but also form the wavefront.

In another exemplary embodiment, the projection grid can alternatively be adjusted to the intrinsic beam divergence. Furthermore, the additional first hologram region can be designed to divert light of the first wavelength of the light beam in an additional beam direction onto the first projection region of the projection surface. In other words, multiple elements of the same wavelength type can illuminate identical points on the projection region. This makes it possible to vary the direction of illumination. This can be utilized in the context of inhomogeneous samples, where the fluorescence depends not only on the intensity but also on the direction of incidence of the excitation light.

FIG. 5 shows a flow chart of a method 700 for exciting a sample according to an exemplary embodiment. The sample is disposed in a microfluidic device disposed in a receiving region of an analyzer. The method 700 comprises a step 705 of emitting a light beam. This is followed by a diverting step 710, in which a first part of the light beam at a first wavelength is diverted in a first beam direction onto a first projection region of a projection surface of the microfluidic device in order to excite the sample disposed in the first projection region. In this exemplary embodiment, the method 700 further comprises a diverting step 715 in which a second part of the light beam at a second wavelength is diverted in a second beam direction onto a second projection region of the projection surface of the microfluidic device in order to excite the sample disposed in the first projection region.

1. An optical apparatus for exciting a sample in a microfluidic device disposed in a receiving region of an analyzer, comprising:
a light source which is designed to emit a light beam; and
a holographic optical element configured to divert at least a part of the light beam onto a projection surface of the microfluidic device in order to excite the sample disposed in the microfluidic device when the microfluidic device is disposed in the receiving region of the analyzer,
wherein the holographic optical element comprises at least a first hologram region and a second hologram region, and
wherein the first hologram region is designed to divert light of a first wavelength of the light beam in a first beam direction onto a first projection region of the projection surface, and the second hologram region is designed to divert light of a second wavelength of the light beam in a second beam direction onto the first projection region and/or a second projection region of the projection surface.

2. The optical apparatus according to claim 1, further comprising a directing device designed to direct the light beam to one of the hologram regions in response to a directing signal.

3. The optical apparatus according to claim 2, further comprising a control device, which is designed to provide the directing signal and/or to provide an action signal in order to switch the light source on and off.

4. The optical apparatus according to one of the preceding claim 1, wherein the light source is designed to emit the light beam of at least one broad wavelength band and/or at a plurality of spaced-apart wavelength lines or wavelength bands.

5. The optical apparatus according to claim 1, wherein the holographic optical element comprises at least one further hologram region, which is designed to divert light of a further wavelength fey of the light beam in a further beam direction onto the first projection region and/or the second projection region and/or a further projection region of the projection surface.

6. The optical apparatus according to claim 1, wherein the holographic optical element is designed to transmit at least a further part of the light beam.

7. The optical apparatus according to claim 1, wherein the device is designed to be able to illuminate the projection surface without gaps.

8. The optical apparatus according to claim 1, wherein the apparatus is designed to illuminate the first projection region and the second projection region at the same intensity.

9. The optical apparatus according to claim 1, wherein:
the holographic optical element comprises at least one additional first hologram region, and
the additional first hologram region is designed to divert the light of the first wavelength (A) of the light beam in an additional beam direction onto the first projection region and/or the second projection region of the projection surface.

10. The optical apparatus according to claim 1, wherein:
the holographic optical element is shaped in a planar manner, and/or
the hologram regions of the holographic optical element are disposed in a matrix-like manner.

11. An analyzer for analyzing a sample in a microfluidic device, comprising:
a receiving region configured to receive the microfluidic device; and
an optical apparatus according to claim 1.

12. A method for exciting a sample in a microfluidic device disposed in a receiving region of an analyzer, comprising:
emitting a light beam; and
diverting light of at least a first wavelength of the light beam in a first beam direction onto a first projection region of a projection surface of the microfluidic device in order to excite the sample disposed in the first projection region when the microfluidic device is disposed in the receiving region; and/or
diverting light of at least a second wavelength of the light beam in a second beam direction onto the first projection region and/or a second projection region of the projection surface of the microfluidic device in order to excite the sample disposed in the first projection region when the microfluidic device is disposed in the receiving region.
